(19) United States
(12) Patent Application Publication
(10) Pub. No.: US 2019/0011800 A1
(43) Pub. Date: Jan. 10, 2019

(54) SEMICONDUCTOR OPTICAL MODULATOR

(71) Applicant: SUMITOMO ELECTRIC INDUSTRIES, LTD., Osaka (JP)

(72) Inventors: Takehiko KIKUCHI, Osaka (JP); Naoya KONO, Osaka (JP)

(73) Assignee: SUMITOMO ELECTRIC INDUSTRIES, LTD., Osaka (JP)

(21) Appl. No.: 16/007,696

(22) Filed: Jun. 13, 2018

(30) Foreign Application Priority Data
Jul. 4, 2017 (JP) 2017-131297

(51) Int. Cl. G02F 1/225

(52) U.S. Cl. CPC G02F 1/2257; G02F 2001/212

(57) ABSTRACT

A semiconductor optical modulator includes an input waveguide provided on a side of a substrate, a first and a second output waveguides provided on the same side of the substrate, a dividing portion optically connected to the input waveguide, eight arm waveguides optically connected to the dividing portion, a first multiplexing portion optically connecting four of the arm waveguides to the first output waveguide, a second multiplexing portion optically connecting the other four of the arm waveguides to the second output waveguide, and modulation electrodes provided on respective ones of the eight arm waveguides. The first and second output waveguides are arranged symmetrically about the input waveguide.

### BACKGROUND OF THE INVENTION

### 1. Field of the Invention

The present invention relates to a semiconductor optical modulator.

### 2. Description of the Related Art

Japanese Unexamined Patent Application Publication No. 2009-229592, hereinafter referred to as Patent Document 1, describes a Mach-Zehnder optical modulator for use in polarization multiplex communication. This modulator includes an electro-optic crystal of, for example, lithium niobate or lithium tantalate. In this modulator, a λ/4 plate and a mirror that are attached to an end of a rectangular substrate change the polarization mode of light that propagates through the modulator from a transverse magnetic (TM) mode to a transverse electric (TE) mode.

Japanese Unexamined Patent Application Publication No. 2012-163876, hereinafter referred to as Patent Document 2, describes a modulator constituted by a Mach-Zehnder semiconductor and applied to quadrature phase shift keying (QPSK). This modulator includes a bent portion constituted by an arc-shaped waveguide that changes the light propagation direction 180° to reduce the size thereof. As illustrated in FIG. 3 of Patent Document 2, an input waveguide and an output waveguide of the modulator are on the same side of a substrate.

### SUMMARY OF THE INVENTION

In an optical communication system, QPSK is used as a method for transmitting 2-bit information by using four phases of signal light. Mach-Zehnder optical modulators are used to generate QPSK signal light. Such a modulator may include an electro-optic crystal of, for example, lithium niobate (LiNbO₃), or a semiconductor such as GaAs or InP. A modulator including an electro-optic crystal is advantageous in that wavelength chirping can be reduced, but has a problem that a large driving voltage is required and it is difficult to reduce the size of the modulator. A modulator including a semiconductor is advantageous in that it is small and can be driven at a high speed and low driving voltage.

Dual polarization QPSK (DP-QPSK), which is one type of QPSK, is a process of transmitting twice as much information by using two QPSK modulators to generate two signal light components in different polarization modes and multiplexing the signal light components. Since a DP-QPSK modulator includes two QPSK modulators, it is desirable to reduce the size thereof. When the two modulators are disposed close to each other on a single substrate to achieve size reduction, it is difficult to arrange input and output waveguides on the same side of the substrate if the modulators include arc-shaped waveguides that are bent 180°.

To solve the above-described problem, a semiconductor optical modulator according to an embodiment includes an input waveguide provided on a side of a substrate; a first and a second output waveguides provided on the side and arranged symmetrically about the input waveguide; a dividing portion optically connected to the input waveguide; eight arm waveguides, each arm waveguide being optically connected to the dividing portion; a first multiplexing portion optically connecting four of the arm waveguides to the first output waveguide; a second multiplexing portion optically connecting the other four of the arm waveguides to the second output waveguide; and modulation electrodes provided on respective ones of the eight arm waveguides.

### BRIEF DESCRIPTION OF THE DRAWINGS

FIG. 1 is a plan view illustrating the structure of a semiconductor optical modulator according to an embodiment.

FIG. 2 is a plan view of the semiconductor optical modulator illustrated in FIG. 1 from which electrodes and electric wiring are removed, illustrating only waveguides and optical couplers.

FIG. 3 is an enlarged plan view illustrating the shape of an input waveguide.

FIG. 4 is an enlarged plan view illustrating the shape of an output waveguide.

FIG. 5 is a schematic plan view illustrating the shapes of waveguides in a first winding path portion.

FIG. 6 is an enlarged plan view illustrating the bent shapes of arm waveguides in a first bent portion and a second bent portion.

FIG. 7 is an enlarged plan view illustrating the bent shapes of arm waveguides in a third bent portion.

FIG. 8 is an enlarged plan view illustrating the bent shapes of arm waveguides in a fourth bent portion.

FIG. 9 is an enlarged plan view illustrating the bent shapes of arm waveguides in a fifth bent portion.

FIG. 10 illustrates a method for manufacturing a semiconductor optical modulator.

FIG. 11 is a plan view illustrating the manner in which four semiconductor optical modulators are arranged adjacent to each other on a wafer.

FIG. 12 is an enlarged plan view of input waveguides that are continuously formed with a straight line therebetween.

FIG. 13 is an enlarged plan view of output waveguides that are continuously formed with a straight line therebetween.

FIGS. 14A and 14B illustrate a method for manufacturing a semiconductor optical modulator.

FIGS. 15A and 15B illustrate the method for manufacturing a semiconductor optical modulator.

FIG. 16 illustrates the method for manufacturing a semiconductor optical modulator.

### DESCRIPTION OF THE PREFERRED EMBODIMENTS

### Description of Embodiments of the Invention

First, embodiments of the present invention will be described. A semiconductor optical modulator according to one embodiment includes an input waveguide provided on a side of a substrate; a first and second output waveguides provided on the side and arranged symmetrically about the input waveguide; a dividing portion optically connected to the input waveguide; eight arm waveguides, each arm waveguide being optically connected to the dividing portion; a first multiplexing portion optically connecting four of the arm waveguides to the first output waveguide; a second multiplexing portion optically connecting the other four of the arm waveguides to the second output waveguide; and modulation electrodes provided on respective ones of the eight arm waveguides.

In the above-described semiconductor optical modulator, the input waveguide and the two output waveguides are provided on the same side of the substrate. When this semiconductor optical modulator is used in a DP-QPSK optical communication system, optical components, such as lenses, are provided outside of the semiconductor optical modulator. In the above-described semiconductor optical modulator, the optical components can be efficiently arranged in the proximity of the substrate of the semiconductor optical modulator. Furthermore, since the two output waveguides and are arranged symmetrically about the input waveguide, the optical components can be more efficiently arranged.

In the above-described semiconductor optical modulator, the first output waveguide, the input waveguide, and the second output waveguide may be arranged in that order at equal intervals along the side of the substrate. When the semiconductor optical modulator is manufactured by forming a plurality of the modulators arranged on a single wafer, the output waveguides and the input waveguide of one modulator can be formed continuously from the output waveguides and the input waveguide of another modulator, and the above-described sides can be formed by, for example, a cleaving process. As a result, additional regions that are generally provided between the adjacent modulators on the wafer to enable separation therealong can be reduced, and the number of modulators that can be formed on a single wafer (yield) can be increased.

The above-described semiconductor optical modulator may further include a first monitor waveguide for monitoring light output from the first multiplexing portion, and a second monitor waveguide for monitoring light output from the second multiplexing portion. The first monitor waveguide and the second monitor waveguide are arranged symmetrically about the input waveguide on the side. In the above-described semiconductor optical modulator, the optical components for the monitor waveguides can be efficiently arranged in the proximity of the substrate of the semiconductor optical modulator.

In the above-described semiconductor optical modulator, four of the arm waveguides may include a first winding path portion that is disposed between the dividing portion and the modulation electrodes. The other four of the arm waveguides may include a second winding path portion that is disposed between the dividing portion and the modulation electrodes. The four of the arm waveguides are bent in the first winding path portion toward a side opposite to a side toward which the other four of the arm waveguides are bent in the second winding path portion. The first winding path portion and the second winding path portion may be arranged mirror symmetrically about a straight line along which the input waveguide extends. With this structure, the arm waveguides connect the dividing portion to the two output waveguides arranged symmetrically about the input waveguide while keeping the optical path length of each arm waveguide equal. Thus, the undesirable phase shift of the light that reach the modulation electrodes can be reduced.

In the above-described semiconductor optical modulator, the first winding path portion may include a first bent portion in which the four of the arm waveguides are bent from a first direction to a second direction; a second bent portion in which, among the four of the arm waveguides extending from the first bent portion, two outer arm waveguides are bent from the second direction to a third direction; a third bent portion in which, among the four of the arm waveguides extending from the first bent portion, two inner arm waveguides are bent from the second direction to a fourth direction; a fourth bent portion in which the two inner arm waveguides extending from the third bent portion are bent from the fourth direction to the third direction; and a fifth bent portion in which, among the two outer arm waveguides extending from the first bent portion, an inner arm waveguide is curved inward. With this structure, the four of the arm wavelengths may have the same optical path length in the first winding path portion. In a preferred embodiment, the four of the arm waveguides may be bent 90° in the first bent portion, the two outer arm waveguides may be additionally bent 90° in the second bent portion, the two inner arm waveguides may be additionally bent 180° in the third bent portion, and the two inner arm waveguides may be additionally bent −90° in the fourth bent portion.

The above-described semiconductor optical modulator, the dividing portion including four optical couplers. The first multiplexing portion including two optical couplers. The second multiplexing portion including two optical couplers. The optical coupler of the dividing portion, the optical coupler of the first or the second multiplexing portion, the arm waveguides, and the modulation electrodes are included in four Mach-Zehnder modulators.

### Detailed Description of Embodiment of the Invention

A semiconductor optical modulator according to an embodiment of the present invention will now be described in detail with reference to the drawings. The present invention is not limited to the embodiment described below. The present invention is defined by the scope of the claims, and is intended to include equivalents to the scope of the claims and all modifications within the scope. In the following description referring to the drawings, the same elements are denoted by the same reference numerals, and redundant description is thus omitted.

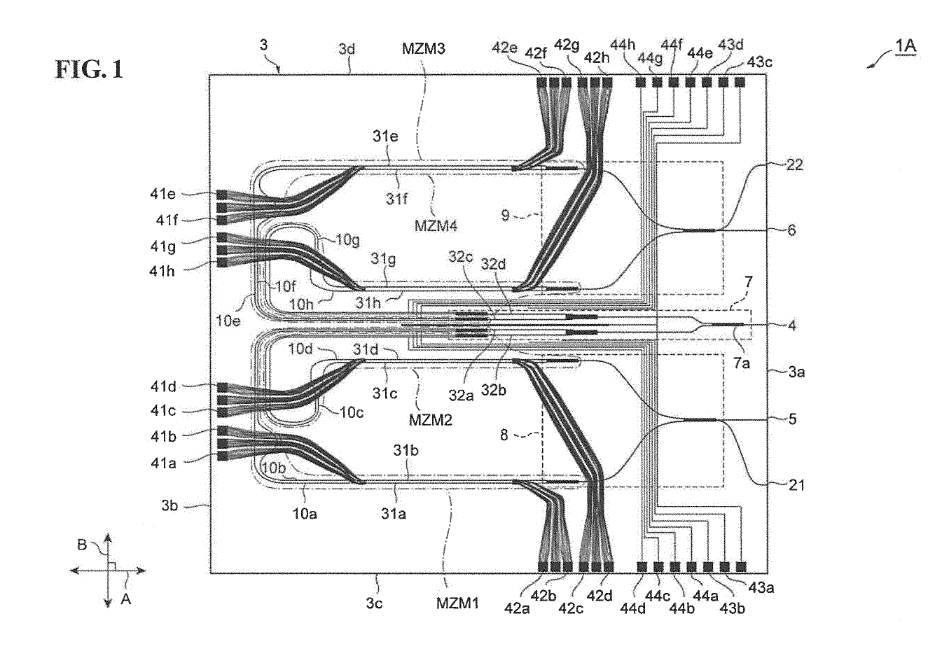

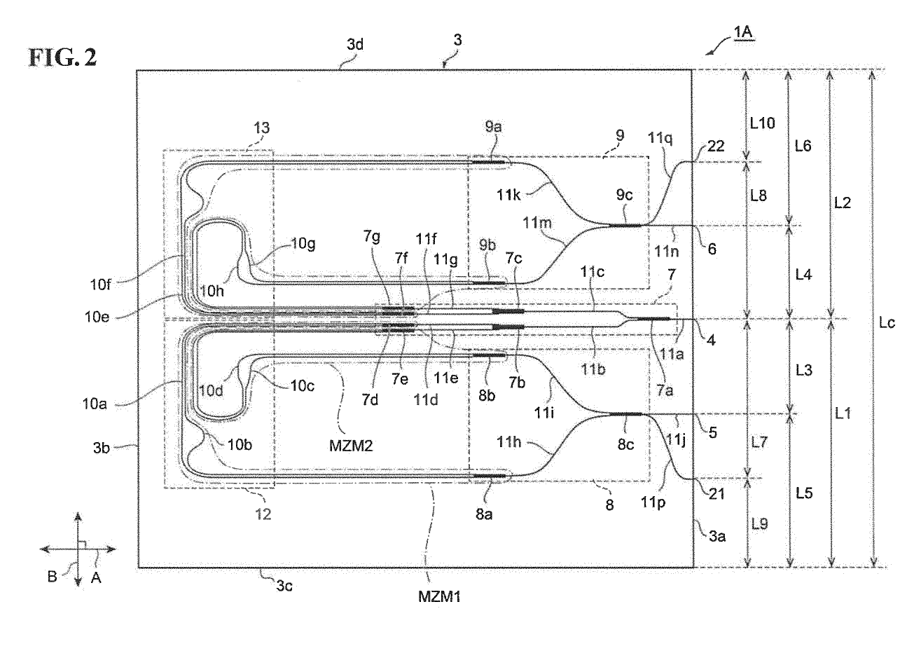

FIG. 1 is a plan view illustrating the structure of a semiconductor optical modulator 1A according to an embodiment of the present invention. FIG. 2 is a plan view of the semiconductor optical modulator 1A illustrated in FIG. 1 from which electrodes and electric wiring are removed, illustrating only waveguides and optical couplers. The semiconductor optical modulator 1A according to the present embodiment includes two QPSK modulators constituted by a GaAs based semiconductor or an InP based semiconductor. As illustrated in FIGS. 1 and 2, the semiconductor optical modulator 1A includes a substrate 3, an input waveguide 4, first and second output waveguides 5 and 6, a dividing portion 7, a first multiplexing portion 8, a second multiplexing portion 9, eight arm waveguides 10a to 10h, and two monitor waveguides 21 and 22. The input waveguide 4, the output waveguides 5 and 6, the arm waveguides 10a to 10h, and the monitor waveguides 21 and 22 include high-mesa-shaped waveguides.

As illustrated in FIG. 1, the semiconductor optical modulator 1A further includes eight modulation electrodes 31a to 31h, four outer phase control electrodes 32a to 32d, and eight inner phase control electrodes, which are not illustrated. The modulation electrodes 31a to 31h are respectively provided on the eight arm waveguides 10a to 10h. Each of the modulation electrodes 31a to 31h is electrically connected to a corresponding one of signal input radio frequency (RF) pads 41a to 41h at one end thereof by a wiring pattern provided on the substrate 3. The other end of each of the modulation electrodes 31a to 31h is electrically connected to a corresponding one of signal terminal RF pads 42a to 42h by a wiring pattern provided on the substrate 3.

The four outer phase control electrodes 32a to 32d are respectively provided on waveguides 11d to 11g. Each of the outer phase control electrodes 32a to 32d is electrically connected to a corresponding one of control signal input direct current (DC) pads 43a to 43d by a wiring pattern provided on the substrate 3. Each of the eight inner phase control electrodes, which are not illustrated, is provided on a corresponding one of the arm waveguides 10a to 10h, which extend from optical couplers 7d to 7g in direction A. Each of the eight inner phase control electrodes is electrically connected to a corresponding one of control signal input DC pads 44a to 44h by a wiring pattern provided on the substrate 3. A resin body (not shown) is disposed on the substrate 3. The resin body embeds the arm waveguides 10a to 10h to flatten the upper surface of the semiconductor optical modulator 1A. The wiring patterns are provided on the resin body. The resin body enables the wiring patterns to pass over the mesa-shaped arm waveguides.

The dividing portion 7 includes an input optical coupler 7a, first and second waveguides 11b and 11c connected to the input optical coupler 7a, and first and second optical couplers 7b and 7c respectively connected to the first and second waveguides 11b and 11c. The dividing portion 7 also includes third and fourth waveguides 11d and 11e connected to the first optical coupler 7b and fifth and sixth waveguides 11f and 11g connected to the second optical coupler 7c. The dividing portion 7 also includes four optical couplers 7d, 7e, 7f, and 7g respectively connected to the third to sixth waveguides 11d, 11e, 11f, and 11g.

The optical coupler 7d is connected to two arm waveguides 10a and 10b, which are connected to an optical coupler 8a. The optical coupler 7e is connected to two arm waveguides 10c and 10d, which are connected to an optical coupler 8b. The optical coupler 7f is connected to two arm waveguides 10e and 10f, which are connected to an optical coupler 9a. The optical coupler 7g is connected to two arm waveguides 10g and 10h, which are connected to an optical coupler 9b.

The first multiplexing portion 8 includes a third optical coupler 8c connected to the first output waveguide 5, two waveguides 11h and 11i connected to the third optical coupler 8c, and optical couplers 8a and 8b respectively connected to the waveguides 11h and 11i. The second multiplexing portion 9 includes a fourth optical coupler 9c connected to the second output waveguide 6, two waveguides 11k and 11m connected to the fourth optical coupler 9c, and optical couplers 9a and 9b respectively connected to the waveguides 11k and 11m.

As illustrated FIGS. 1 and 2, the semiconductor optical modulator 1A includes four Mach-Zehnder modulators MZM1 to MZM4. The optical couplers 7d and 8a, the arm waveguides 10a and 10b, and the modulation electrodes 31a and 31b are included in the first Mach-Zehnder modulator MZM1. The optical couplers 7e and 8b, the arm waveguides 10c and 10d, and the modulation electrodes 31c and 31d are included in the second Mach-Zehnder modulator MZM2. The optical couplers 7f and 9a, the arm waveguides 10e and 10f, and the modulation electrodes 31e and 31f are included in the third Mach-Zehnder modulator MZM3. The optical couplers 7g and 9b, the arm waveguides 10g and 10h, and the modulation electrodes 31g and 31h are included in the fourth Mach-Zehnder modulator MZM4. The first and second Mach-Zehnder modulators MZM1 and MZM2, the optical couplers 7b and 8c, and the waveguides 11e, 11d, and 11h constitute a first QPSK modulator. The third and fourth Mach-Zehnder modulator MZM3 and MZM4, the optical couplers 7c and 9c, and the waveguides 11f, 11g, and 11k constitute a second QPSK modulator.

The first and second Mach-Zehnder modulators MZM1 and MZM2 are both bent at intermediate positions along the arm waveguides thereof. The arm waveguides 10a and 10b of the first Mach-Zehnder modulator MZM1 extend on the outer side of the arm waveguides 10c and 10d of the second Mach-Zehnder modulator MZM2. The distance along direction B between the optical couplers 7d and 8a of the first Mach-Zehnder modulator MZM1 is greater than the distance between the optical couplers 7e and 8b of the second Mach-Zehnder modulator MZM2. The third and fourth Mach-Zehnder modulators MZM3 and MZM4 are both bent at intermediate positions along the arm waveguides thereof. The arm waveguides 10e and 10f of the third Mach-Zehnder modulator MZM3 extend on the outer side of the arm waveguides 10g and 10h of the fourth Mach-Zehnder modulator MZM4. The distance along direction B between the optical couplers 7f and 9a of the third Mach-Zehnder modulator MZM3 is greater than the distance between the optical couplers 7g and 9b of the fourth Mach-Zehnder modulator MZM4.

The substrate 3 is a GaAs substrate or an InP substrate. The substrate 3 has two sides 3a and 3b parallel to direction A and two sides 3c and 3d parallel to direction B, which is orthogonal to direction A. The length of the sides 3a and 3b is, for example, from 8 mm to 9 mm, and the length of the sides 3c and 3d is, for example, from 10 mm to 12 mm.

The input waveguide 4 is a waveguide to which continuous light is input, and is provided on the side 3a of the substrate 3. The input waveguide 4 extends along a first direction (direction A). The side 3a extends along a second direction (direction B). The continuous light is emitted from a light source, such as a semiconductor laser device, provided outside the semiconductor optical modulator 1A.

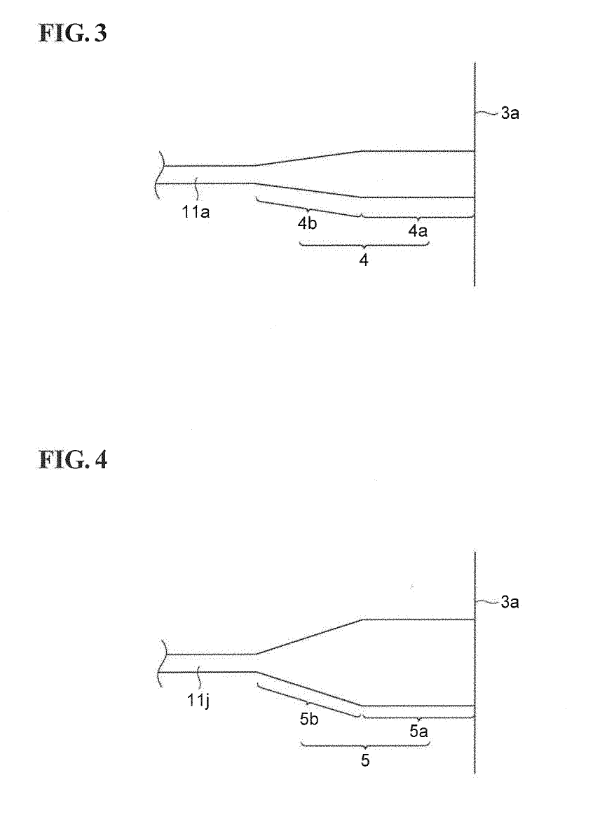

FIG. 3 is an enlarged plan view of the input waveguide 4. As illustrated in FIG. 3, the input waveguide 4 includes a wide portion 4a and a tapered portion 4b. The wide portion 4a has a width greater than that of the waveguide 11a, and guides light having a greater mode field diameter than that of light guided by the waveguide 11a. The wide portion 4a is provided in consideration of displacement of the position in a fabrication process. The tapered portion 4b is provided between the waveguide 11a and the wide portion 4a, and has a width that decreases with increasing distance from the wide portion 4a toward the waveguide 11a. The light having a large mode field diameter input to the input waveguide 4 travels through the tapered portion 4b while the mode field diameter thereof gradually decreases, and is thereby converted into light having a mode field diameter suitable for the waveguide 11a. The input waveguide 4 includes the tapered portion 4b to increase the optical coupling efficiency. The width of the wide portion 4a is, for example, 4 μm, and the width of the waveguide 11a is, for example, 1.5 μm. The length of the wide portion 4a is, for example, 100 μm, and the length of the tapered portion 4b is, for example, 500 μm. The input waveguide 4 has a mesa shape. The height of the mesa is, for example, 1.5 μm.

Referring to FIGS. 1 and 2 again, the input waveguide 4 is at the center of the side 3a in direction B. In other words, a distance L1 from the side 3c to the central axis of the input waveguide 4 is equal to a distance L2 from the side 3d to the central axis of the input waveguide 4, and the distances L1 and L2 are equal to half a distance Lc between the sides 3c and 3d, that is, the length of the side 3a.

The first and second output waveguides 5 and 6 are waveguides from which signal light components that are QPSK modulated by the semiconductor optical modulator 1A are output, and are provided on the side 3a of the substrate 3. The first and second output waveguides 5 and 6 extend along a first direction (direction A). FIG. 4 is an enlarged plan view of the output waveguide 5. The shape of the output waveguide 6 in plan view is the same as that of the output waveguide 5. As illustrated in FIG. 4, the output waveguide 5 includes a wide portion 5a and a tapered portion 5b. The wide portion 5a has a width greater than that of the waveguide 11j, and guides light having a greater mode field diameter than that of light guided by the waveguide 11j. The wide portion 5a is provided in consideration of displacement of the position at which a wafer is cleaved to form the substrate 3 in the manufacturing process of the semiconductor optical modulator 1A described below. The tapered portion 5b is provided between the waveguide 11j and the wide portion 5a, and has a width that gradually increases with increasing distance from the waveguide 11j toward the wide portion 5a.

Referring to FIGS. 1 and 2 again, the output waveguides 5 and 6 are arranged mirror-symmetrically about the input waveguide 4. In other words, the output waveguides 5 and 6 are on opposite sides of the input waveguide 4. The output waveguide 5, the input waveguide 4, and the output waveguide 6 are arranged in that order at equal intervals in direction B. End portions of the output waveguide 5, the input waveguide 4, and the output waveguide 6 are in contact with the side 3a. A distance L3 from the central axis of the input waveguide 4 to the central axis of the output waveguide 5 is equal to a distance L4 from the central axis of the input waveguide 4 to the central axis of the output waveguide 6. As described above, the input waveguide 4 is at the center of the side 3a. Therefore, a distance L5 from the side 3c to the central axis of the output waveguide 5 is equal to a distance L6 from the side 3d to the central axis of the output waveguide 6. The distances L3 and L4 are, for example, 1 mm.

The dividing portion 7 divides the light input through the input waveguide 4 along the eight arm waveguides 10a to 10h. The dividing portion 7 according to the present embodiment includes one optical coupler 7a at a first stage, two optical couplers 7b and 7c at a second stage, and four optical couplers 7d to 7g at a last stage. The optical couplers 7a to 7g are 1-input/2-output multi-mode interferometer (MMI) couplers. An input end of the optical coupler 7a is coupled to the input waveguide 4 by the waveguide 11a. One output end of the optical coupler 7a is coupled to an input end of the optical coupler 7b by the waveguide 11b, and the other output end of the optical coupler 7a is coupled to an input end of the optical coupler 7c by the waveguide 11c.

One output end of the optical coupler 7b is coupled to an input end of the optical coupler 7d by the waveguide 11d, and the other output end of the optical coupler 7b is coupled to an input end of the optical coupler 7e by the waveguide 11e. One output end of the optical coupler 7c is coupled to an input end of the optical coupler 7f by the waveguide 11f, and the other output end of the optical coupler 7c is coupled to an input end of the optical coupler 7g by the waveguide 11g.

Two output ends of the optical coupler 7d are each coupled to one end of a corresponding one of the arm waveguides 10a and 10b. Two output ends of the optical coupler 7e are each coupled to one end of a corresponding one of the arm waveguides 10c and 10d. Two output ends of the optical coupler 7f are each coupled to one end of a corresponding one of the arm waveguides 10e and 10f. Two output ends of the optical coupler 7g are each coupled to one end of a corresponding one of the arm waveguides 10g and 10h.

The first multiplexing portion 8 multiplexes light components propagated through the four arm waveguides 10a to 10d, and supplies the multiplexed light to the output waveguide 5. The first multiplexing portion 8 according to the present embodiment includes two optical couplers 8a and 8b at a first stage and one optical coupler 8c at a last stage. The optical couplers 8a and 8b are 2-input/1-output MIMI couplers. The optical coupler 8c is a 2-input/2-output MMI coupler. Two input ends of the optical coupler 8a are each coupled to the other end of a corresponding one of the arm waveguides 10a and 10b. Two input ends of the optical coupler 8b are each coupled to the other end of a corresponding one of the arm waveguides 10c and 10d. Output ends of the optical couplers 8a and 8b are each coupled to a corresponding one of two input ends of the optical coupler 8c by the waveguides 11h and 11i, respectively. One output end of the optical coupler 8c is coupled to the output waveguide 5 by the waveguide 11j.

The second multiplexing portion 9 multiplexes light components propagated through the other four arm waveguides 10e to 10h, and supplies the multiplexed light to the output waveguide 6. The structure of the second multiplexing portion 9 is similar to that of the first multiplexing portion 8. More specifically, the second multiplexing portion 9 includes two optical couplers 9a and 9b at a first stage and one optical coupler 9c at a last stage. The optical couplers 9a and 9b are 2-input/1-output MMI couplers. The optical coupler 9c is a 2-input/2-output MMI coupler. Two input ends of the optical coupler 9a are each coupled to the other end of a corresponding one of the arm waveguides 10e and 10f. Two input ends of the optical coupler 9b are each coupled to the other end of a corresponding one of the arm waveguides 10g and 10h. Output ends of the optical couplers 9a and 9b are each coupled to a corresponding one of two input ends of the optical coupler 9c by the waveguides 11k and 11m, respectively. One output end of the optical coupler 9c is coupled to the output waveguide 6 by the waveguide 11n.

The monitor waveguide 21, which corresponds to a first monitor waveguide, is a waveguide used to monitor the intensity of light output from the first multiplexing portion 8. The monitor waveguide 22, which corresponds to a second monitor waveguide, is a waveguide used to monitor the intensity of light output from the second multiplexing portion 9. The monitor waveguide 21 is coupled to the other output end of the optical coupler 8c by the waveguide 11p. The monitor waveguide 22 is coupled to the other output end of the optical coupler 9c by the waveguide 11q. The shape of the monitor waveguides 21 and 22 in plan view is similar to the shape of the output waveguide 5 in plan view illustrated in FIG. 4.

The monitor waveguides 21 and 22 are arranged symmetrically about the input waveguide 4 on the side 3a of the substrate 3. In other words, the monitor waveguides 21 and 22 are on opposite sides of the input waveguide 4. A distance L7 from the central axis of the input waveguide 4 to the central axis of the monitor waveguide 21 is equal to a distance L8 from the central axis of the input waveguide 4 to the central axis of the monitor waveguide 22. As described above, the input waveguide 4 is at the center of the side 3a. Therefore, a distance L9 from the side 3c to the central axis of the monitor waveguide 21 is equal to a distance L10 from the side 3d to the central axis of the monitor waveguide 22. The monitor waveguide 21, the output waveguide 5, the input waveguide 4, the output waveguide 6, and the monitor waveguide 22 are arranged along the side 3a in that order in direction B. The distances L7 and L8 are, for example, 2 mm, when the distances L3 and L4 are 1 mm.

As illustrated in FIG. 1, the modulation electrodes 31a to 31h, which are respectively provided on the eight arm waveguides 10a to 10h, individually apply voltage signals modulated in accordance with transmission signals to the arm waveguides 10a to 10h, thereby changing the refractive indices of the arm waveguides 10a to 10h. Thus, the phases of the light propagated through arm waveguides 10a to 10h are modulated.

The four outer phase control electrodes 32a to 32d are respectively provided on the waveguides 11d to 11g. The outer phase control electrodes 32a to 32d individually apply phase control voltages, which are DC voltages, to the waveguides 11d to 11g to adjust the phases of the continuous light by changing the refractive indices of the waveguides 11d to 11g. The eight inner phase control electrodes, which are not illustrated, are respectively provided on the arm waveguides 10a to 10h that extend from the optical couplers 7d to 7g in direction A. The inner phase control electrodes individually apply phase control voltages, which are DC voltages, to the arm waveguides 10a to 10h to adjust the phases of the continuous light by changing the refractive indices of the arm waveguides 10a to 10h.

The structure of the waveguides included in the semiconductor optical modulator 1A will now be described in detail. As described above, in the present embodiment, the input waveguide 4, the two output waveguides 5 and 6, and the two monitor waveguides 21 and 22 are all provided on the side 3a of the rectangular substrate 3. Continuous light having a wavelength of 1.55 μm, for example, is input to the input waveguide 4. Since the input waveguide 4 and the output waveguides 5 and 6 are on the same side 3a, the light input to the input waveguide 4 and propagated in a direction away from the side 3a needs to return to the side 3a, where the output waveguides 5 and 6 are provided, by changing the traveling direction thereof 180°.

The continuous light is QPSK modulated by the four Mach-Zehnder modulators, and output from the output waveguides 5 and 6 as QPSK modulated signal light components. In the QPSK modulation, it is necessary to reduce the skew of the signal light components output from the output waveguides 5 and 6. For this purpose, the difference between the time required for light to pass through the first Mach-Zehnder modulator MZM1 and the time required for light to pass through the second Mach-Zehnder modulator MZM2 needs to be shorter than a predetermined time. In other words, the times need to be substantially equal. To make the times substantially equal, the difference in optical path length between the four arm waveguides needs to be as small as possible.

Similarly, the difference between the time required for light to pass through the third Mach-Zehnder modulator MZM3 and the time required for light to pass through the fourth Mach-Zehnder modulator MZM4 needs to be shorter than a predetermined time. In other words, the times need to be substantially equal.

As illustrated in FIG. 2, the arm waveguides 10a to 10d according to the present embodiment include a first winding path portion 12 between the dividing portion 7 and the modulation electrodes 31a to 31d. The continuous light from the dividing portion 7 is propagated away from the side 3a in direction A through the waveguides. The first winding path portion 12 reverses the traveling direction of the continuous light so that the continuous light is propagated toward the side 3a. The continuous light that travels in the direction toward the side 3a is modulated by the voltage signals applied by the modulation electrodes 31a to 31d, and are converted into signal light components that travel toward the side 3a. Similarly, the arm waveguides 10e to 10h include a second winding path portion 13 between the dividing portion 7 and the modulation electrodes 31e to 31h. The second winding path portion 13 also changes the light traveling direction from the direction away from the side 3a to the direction toward the side 3a.

The arm waveguides 10a to 10h has a high-mesa structure. The width and height of the mesa of the waveguide are both 1.5 μm, for example. This high-mesa structure allows small optical losses even when the arm waveguides 10a to 10h are bent with small bend radii. In the first winding path portion 12, the arm waveguides 10a to 10d are bent away from a reference line that passes through the input waveguide 4 in direction A toward the output waveguide 5. In the second winding path portion 13, the arm waveguides 10e to 10h are bent away from the reference line that passes through the input waveguide 4 in direction A toward the output waveguide 6. The arm waveguides 10a to 10d have the same optical path length in the first winding path portion 12, and the arm waveguides 10e to 10h have the same optical path length in the second winding path portion 13.

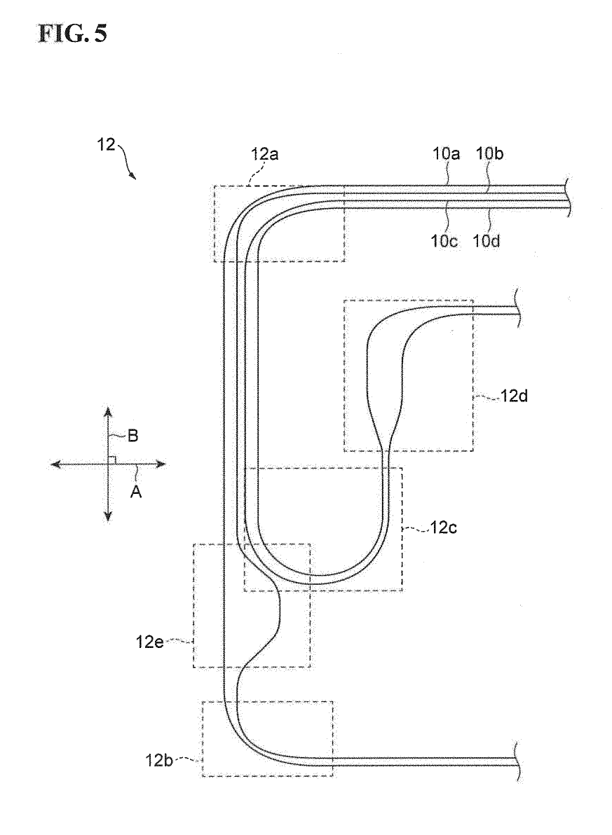

FIG. 5 is a schematic plan view illustrating the shapes of the waveguides in the first winding path portion 12. The structure of the waveguides in the second winding path portion 13 in plan view is mirror symmetrical to the structure of the waveguides in the first winding path portion 12 about the reference line that passes through the input waveguide 4 in direction A. As illustrated in FIG. 5, the first winding path portion 12 according to the present embodiment includes a first bent portion 12a, a second bent portion 12b, a third bent portion 12c, a fourth bent portion 12d, and a fifth bent portion 12e. Straight waveguides are provided between the bent portions so as to connect the bent portions.

In the first bent portion 12a, the arm waveguides 10a to 10d are bent from a direction along the side 3d, that is, direction A, to a direction along the side 3b, that is, direction B. In one embodiment, the arm waveguides 10a to 10d each include one 90° bent waveguide in the first bent portion 12a. In the first bent portion 12a, the pair of arm waveguides 10a and 10b included in the first Mach-Zehnder modulator MZM1 and the pair of arm waveguides 10c and 10d included in the second Mach-Zehnder modulator MZM2 are bent together in the same direction. In the second bent portion 12b, among the arm waveguides 10a to 10d extending from the first bent portion 12a, two outer arm waveguides 10a and 10b are bent from the direction along the side 3b, that is, direction B, to the direction along the side 3c, that is, direction A. In one embodiment, the two outer arm waveguides 10a and 10b each include one 90° bent waveguide in the second bent portion 12b. Thus, the arm waveguides 10a and 10b are bent 180° by the first bent portion 12a and the second bent portion 12b.

In the third bent portion 12c, among the arm waveguides 10a to 10d extending from the first bent portion 12a, two inner arm waveguides 10c and 10d are bent 180°. In one embodiment, the two inner arm waveguides 10c and 10d each include one 180° bent waveguide in the third bent portion 12c. In the third bent portion 12c, the arm waveguides 10c and 10d each include two straight waveguides that extend in direction B and the 180° bent waveguide that connects the two straight waveguides to each other. The 180° bend such as that in the third bent portion 12c is included only in the arm waveguides of the second Mach-Zehnder modulator MZM2, and is not included in the arm waveguides of the first Mach-Zehnder modulator MZM1. Thus, the difference in optical path length between the first Mach-Zehnder modulator MZM1 and the second Mach-Zehnder modulator MZM2 is reduced. As a result, skew of the signal light component output from the first output waveguide 5 of the modulator 1A can be reduced. In addition, the structure in which only the inner arm waveguides included in the second Mach-Zehnder modulator MZM2 include the 180° bend enables a reduction in the distance from the optical coupler 7b to the optical coupler 8a in direction B. As a result, the width of the semiconductor optical modulator 1A in direction B, that is, the length of the sides 3a and 3b, can be reduced, and the size of the modulator 1A can be reduced accordingly.

In the fourth bent portion 12d, the two inner arm waveguides 10c and 10d extending from the third bent portion 12c are bent from the direction along the side 3b, that is, direction B, to the direction toward the side 3a, that is, direction A. In one embodiment, in the fourth bent portion 12d, the arm waveguides 10c and 10d each include one 90° bent waveguide. In one embodiment, the two inner arm waveguides 10c and 10d are bent −90° in the fourth bent portion 12d. The fifth bent portion 12e is provided between the first bent portion 12a and the second bent portion 12b. In the fifth bent portion 12e, among the two outer arm waveguides 10a and 10b extending from the first bent portion 12a, the outer arm waveguide 10a continuously extends linearly, and the inner arm waveguide 10b is inwardly curved. More specifically, the arm waveguide 10b includes a bent waveguide in the fifth bent portion 12e.

The arm waveguide 10a belonging to the first Mach-Zehnder modulator MZM1 is bent twice, first in a first bent portion 12a and then in a second bent portion 12b. The arm waveguide 10b belonging to the first Mach-Zehnder modulator MZM1 is bent three times, in the bent portions 12a, 12b and 12e. The arm waveguides 10c and 10d belonging to the second Mach-Zehnder modulator MZM2 are bent three times, in the bent portions 12a, 12c and 12d. This bending structure effectively reduces the skew between the MZM1 and MZM2, while all arm waveguides belonging to the two MZMs return toward the side 3a.

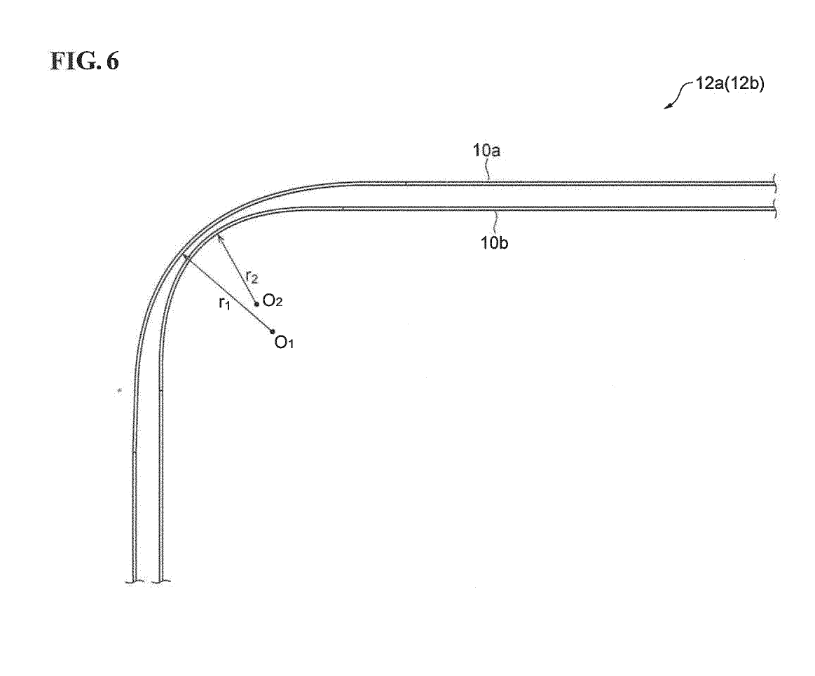

FIG. 6 is an enlarged plan view illustrating the bent shapes of the arm waveguides 10a and 10b in the first bent portion 12a and the second bent portion 12b. In the first bent portion 12a, the shapes of the arm waveguides 10c and 10d are similar to those of the arm waveguides 10a and 10b. As illustrated in FIG. 6, in the first bent portion 12a and the second bent portion 12b, the arm waveguides 10a and 10b each include a bent waveguide and straight waveguides connected to both ends of the bent waveguide. In the first bent portion 12a and the second bent portion 12b, the optical path length of the outer arm waveguide 10a is longer than that of the inner arm waveguide 10b. To reduce the difference in optical path length, the arm waveguides 10a and 10b are bent in different shapes. More specifically, the outer arm waveguide 10a is curved more gently than the inner arm waveguide 10b. For example, when the bent waveguides are arc-shaped, a radius of curvature r₁ of the outer arm waveguide 10a is greater than a radius of curvature r₂ of the inner arm waveguide 10b. The gap between the bent waveguides of the two arm waveguides 10a and 10b is smaller than that between the straight waveguides of the two arm waveguides 10a and 10b. A center O₂ of the radius of curvature r₂ of the arm waveguide 10b is closer to the arm waveguides (outside) than a center O₁ of the radius of curvature r₁ of the arm waveguide 10a is. Thus, the outer arm waveguide 10a and the inner arm waveguide 10b are shaped so as to reduce the difference between the optical path lengths thereof.

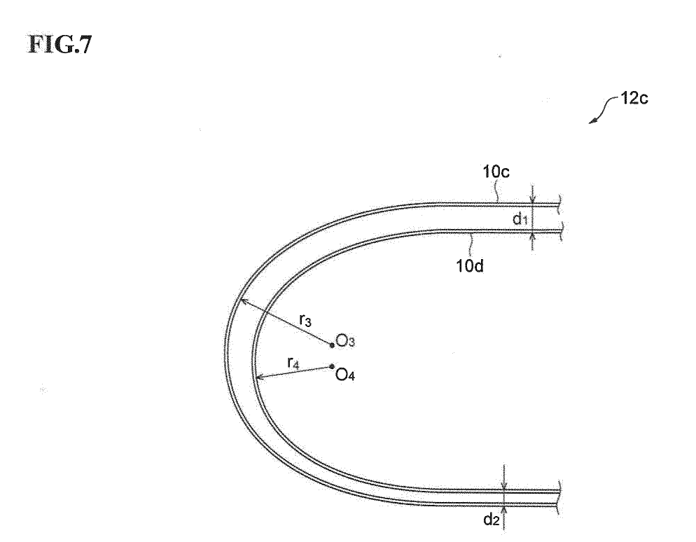

FIG. 7 is an enlarged plan view illustrating the bent shapes of the arm waveguides 10c and 10d in the third bent portion 12c. As illustrated in FIG. 7, in the third bent portion 12c, the arm waveguides 10c and 10d each include a bent section, a straight section located upstream of the bent section, and a straight section located downstream of the bent section. In the third bent portion 12c, the optical path length of the outer arm waveguide 10c is longer than that of the inner arm waveguide 10d. To reduce the difference in optical path length, the arm waveguides 10c and 10d are bent in different shapes. More specifically, a radius of curvature r₃ of the outer arm waveguide 10c is greater than a radius of curvature r₄ of the inner arm waveguide 10d. In addition, a gap d₂ between the arm waveguides 10c and 10d in a region downstream of the bent sections is smaller than a gap d₁ between the arm waveguides 10c and 10d in a region upstream of the bent section. In other words, a center O₄ of the radius of curvature r₄ of the arm waveguide 10d is closer to the region downstream of the bent sections than a center O₃ of the radius of curvature r₃ of the arm waveguide 10c is. Thus, the arm waveguides 10c and 10d in the third bent portion 12c are shaped so as to reduce the difference between the optical path lengths thereof.

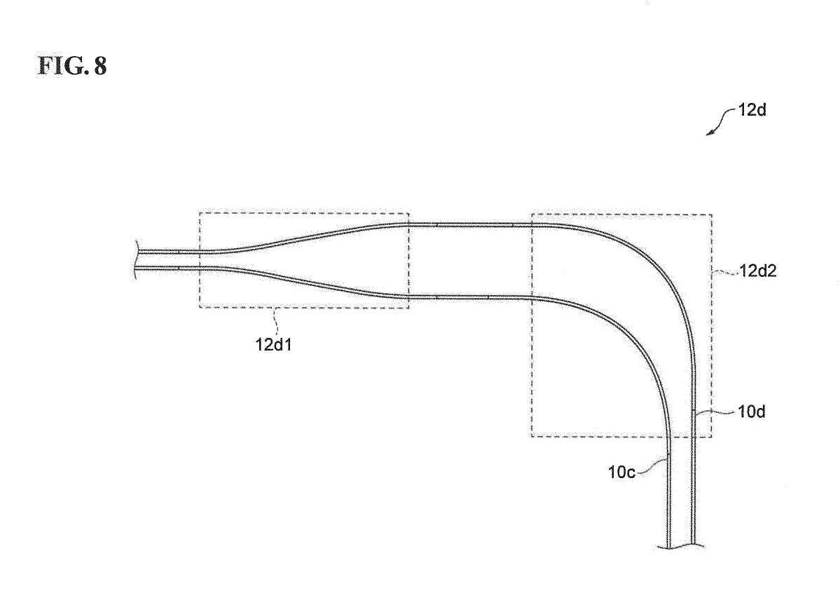

FIG. 8 is an enlarged plan view illustrating the bent shapes of the arm waveguides 10c and 10d in the fourth bent portion 12d. As illustrated in FIG. 8, in the fourth bent portion 12d, the arm waveguides 10c and 10d have a section 12d1 in which the two waveguides are bent away from each other so that the gap therebetween increases and a section 12d2 in which the two waveguides are bent in the same direction. In these sections 12d1 and 12d2, the curvature of the arm waveguide 10c is equal to the curvature of the arm waveguide 10d. In the section 12d2 in which the two waveguides are bent in the same direction, the optical path length of the outer arm waveguide 10d is longer than that of the inner arm waveguide 10c. In the section 12d1 in which the two waveguides are bent away from each other, the difference in optical path length between the arm waveguides 10c and 10d can be adjusted by changing the gap between the arm waveguides 10c and 10d. More specifically, as the two waveguides are bent farther away from each other in the section 12d1, the difference in optical path length between the arm waveguides 10d and 10c in the fourth bent portion 12d increases. In the fourth bent portion 12d, the optical path length of the arm waveguide 10d is longer than that of the arm waveguide 10c. In the above-described first bent portion 12a and the third bent portion 12c, the optical path length of the arm waveguide 10d is shorter than that of the arm waveguide 10c. Since the fourth bent portion 12d includes the section 12d1 in which the gap between the waveguides is increased and the section 12d2 in which the waveguides are bent together, the difference in optical path length between the arm waveguides 10c and 10d generated in the first and second bent portions 12a and 12b can be cancelled, so that the optical path lengths of the arm waveguides 10c and 10d approach each other.

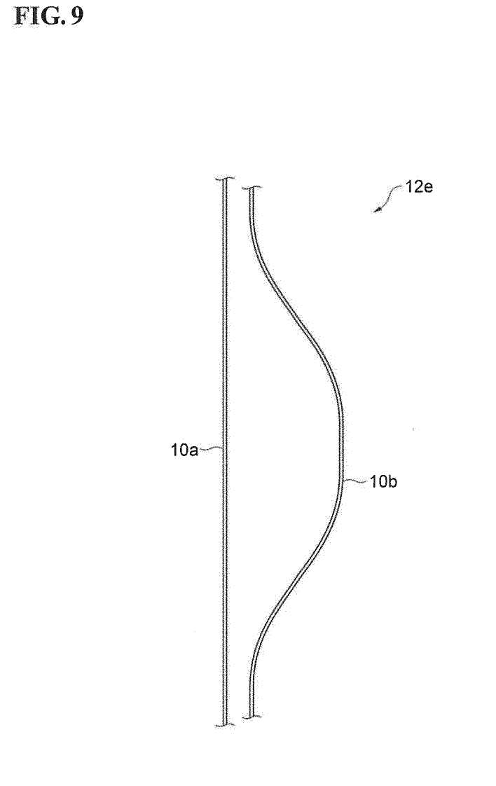

FIG. 9 is an enlarged plan view illustrating the bent shapes of the arm waveguides 10a and 10b in the fifth bent portion 12e. In the fifth bent portion 12e, among the arm waveguides 10a and 10b, the inner arm waveguide 10b is curved inward away from the outer arm waveguide 10a. In other words, the distance between the arm waveguides 10a and 10b is greater in the fifth bent portion 12e that in regions upstream and downstream of the fifth bent portion 12e. Here, the arm waveguide 10a continuously extends linearly. In the fifth bent portion 12e, the optical path length of the arm waveguide 10b is longer than that of the arm waveguide 10a. In the above-described first bent portion 12a and the second bent portion 12b, the optical path length of the arm waveguide 10b is shorter than that of the arm waveguide 10a. Thus, the optical path lengths are adjusted in the fifth bent portion 12e. As a result, the arm waveguides 10a and 10b have the same optical path length.

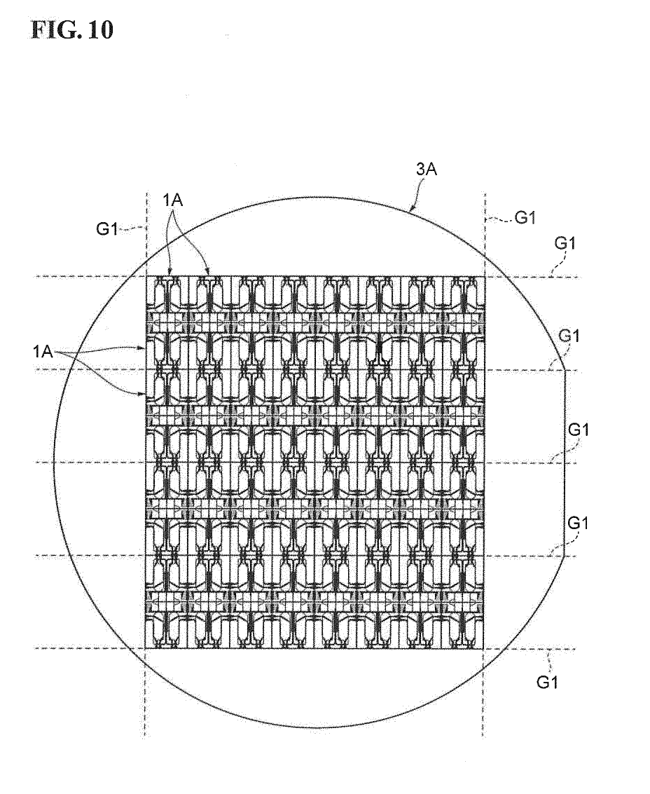

A method for manufacturing the semiconductor optical modulator 1A having the above-described structure according to the present embodiment will now be described. First, as illustrated in FIG. 10, a plurality of semiconductor optical modulators 1A are formed on a wafer 3A, which serves as the substrate 3, by a common modulator production method. At this time, no clearances for cutting the wafer 3A are provided between the semiconductor optical modulators 1A that are adjacent to each other. Therefore, the semiconductor optical modulators 1A that are adjacent to each other are in contact with each other. The wafer 3A has a diameter of, for example, 3 inches, and a thickness of, for example, 100 μm.

The input and output waveguides, optical couplers, and arm waveguides included in each semiconductor optical modulator 1A are high-mesa-shaped. The mesa height is, for example, 2 μm. The mesa width of the arm waveguides is, for example, 1.5 μm. The mesas that constitute the arm waveguides include a stacked semiconductor layer. The stacked semiconductor layer is obtained by, for example, stacking a lower cladding layer made of InP, a core layer including AlGaInAs multi-quantum wells, and an upper cladding layer made of InP in that order on an InP substrate. The refractive index of the core layer is, for example, 3.4 at a wavelength of 1.55 μm, and the refractive index of the upper and lower cladding layers is 3.2. The side surfaces of the arm waveguides are covered with, for example, an inorganic film made of silicon dioxide or silicon nitride having a refractive index of about 1.5. The inorganic film functions as a cladding layer on the side surfaces of the core layer. With this structure, light can be reliably confined in the core of each waveguide. Accordingly, even when the waveguides are acutely bent, that is, even when the radius of curvature of the bent waveguides is reduced, loss of light guided through the bent waveguides does not easily occur. This enables the semiconductor optical modulator 1A to include a plurality of bent waveguides in each winding path portion.

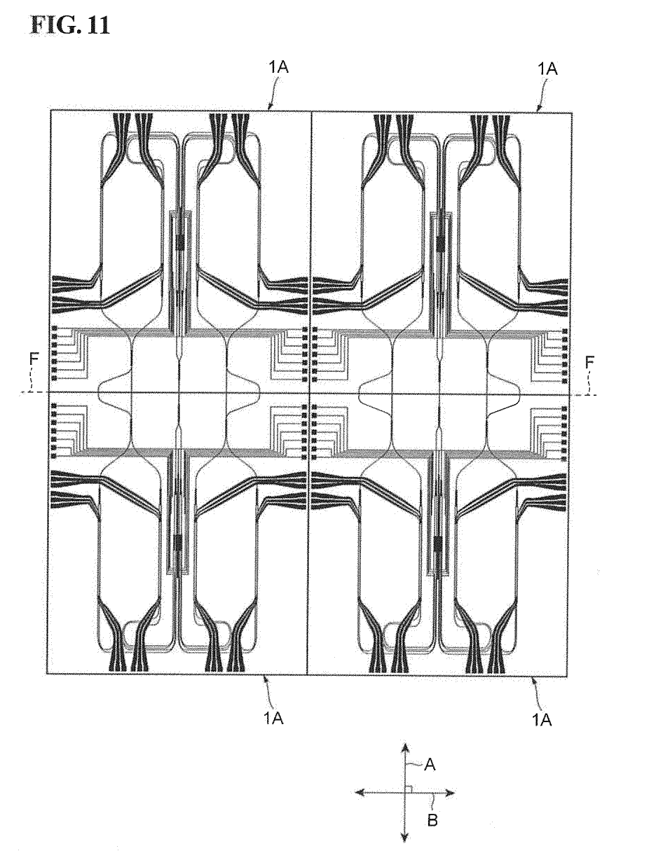

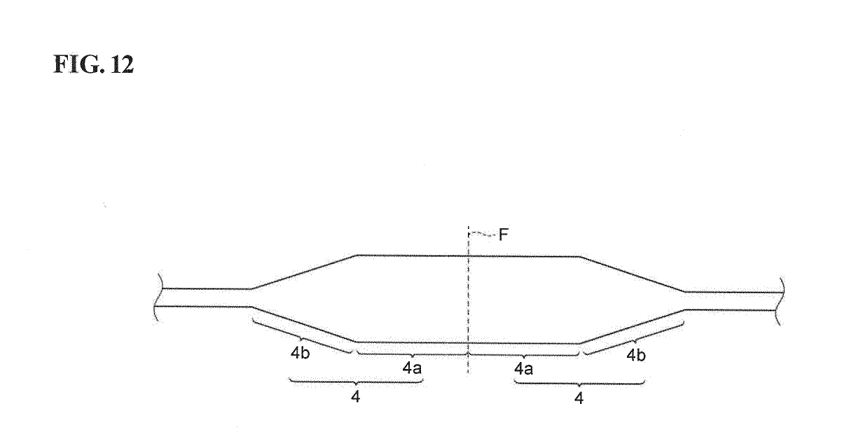

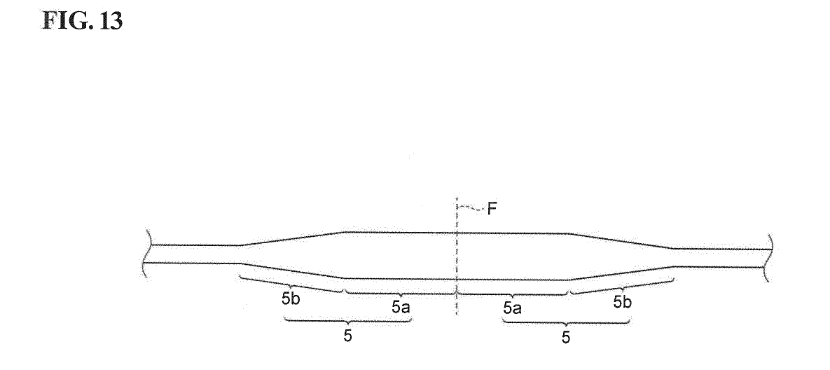

FIG. 11 is an enlarged plan view of four semiconductor optical modulators 1A arranged adjacent to each other on the wafer 3A. As illustrated in FIG. 11, two semiconductor optical modulators 1A that are adjacent to each other in direction A face each other with a shared straight line F therebetween, the straight line F defining the sides 3a of the semiconductor optical modulators 1A. As described above, in each semiconductor optical modulator 1A, the input waveguide 4 is at the center of the side 3a, and the output waveguides 5 and 6 are arranged symmetrically about the input waveguide 4. The monitor waveguides 21 and 22 are also arranged symmetrically about the input waveguide 4. Therefore, the input waveguide 4, the output waveguides 5 and 6, and the monitor waveguides 21 and 22 of one of the semiconductor optical modulators 1A that are adjacent to each other in direction A extend continuously from the input waveguide 4, the output waveguides 5 and 6, and the monitor waveguides 21 and 22 of the other semiconductor optical modulator 1A with the straight line F therebetween. FIG. 12 is an enlarged plan view of the input waveguides 4 that extend continuously from each other with the straight line F therebetween. FIG. 13 is an enlarged plan view of the output waveguides 5 that extend continuously from each other with the straight line F therebetween.

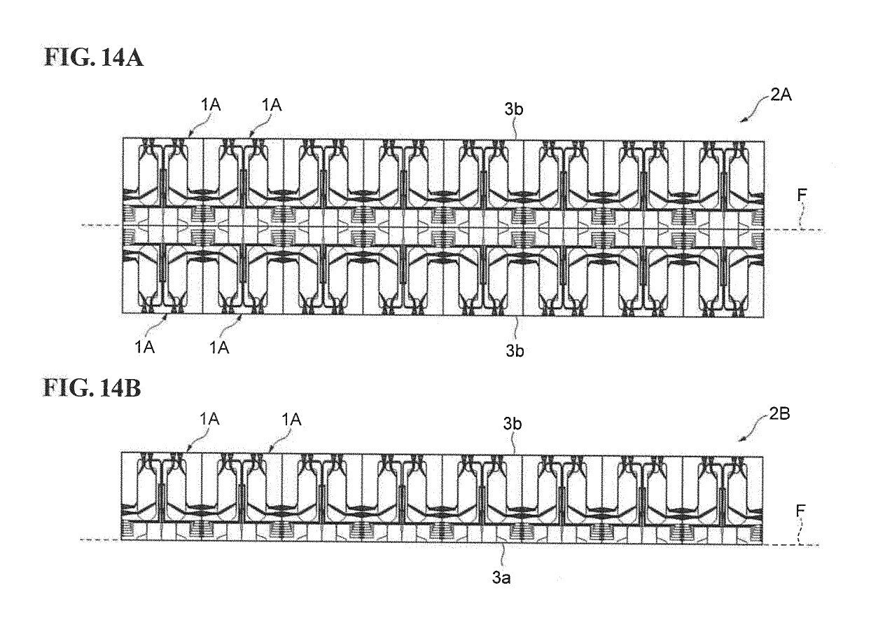

Next, the wafer 3A is broken along the cutting lines G1 illustrated in FIG. 10 to obtain a plate-shaped product 2A illustrated in FIG. 14A in which the semiconductor optical modulators 1A are arranged in two rows along the straight line F. The breaking process is a process of forming scribe grooves along the cutting lines G1 by using a diamond tool and splitting the wafer 3A along the scribe grooves. Then, the product 2A is cleaved along the straight line F. Thus, a plate-shaped product 2B illustrated in FIG. 14B in which the semiconductor optical modulators 1A are arranged in a single row along the straight line F is obtained. The cleaving process is a process of splitting the plate-shaped product 2A along a crystal plane, and flat end faces can be obtained as a result. As a result of the cleaving process, the input waveguides 4 illustrated in FIG. 12, the output waveguides 5 illustrated in FIG. 13, the output waveguides 6, and the monitor waveguides 21 and 22 of the semiconductor optical modulators 1A that are adjacent to each other are separated from each other along the straight line F so that end faces are formed thereon. In addition, the side 3a of the substrate 3 is also formed on each semiconductor optical modulator 1A.

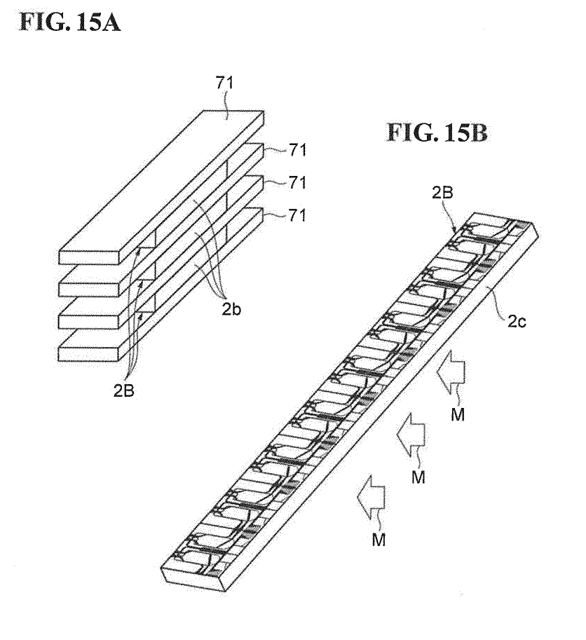

Next, as illustrated in FIG. 15A, a plurality of the products 2B are placed between a plurality of plate-shaped spacers 71. The plate-shaped spacers 71 are made of, for example, silicon (Si). End faces 2b of the products 2B are exposed between the plate-shaped spacers 71. Next, as illustrated in FIG. 15B, a material M of an anti-reflection coating film is applied to the end faces 2b so that an anti-reflection coating film 2c is formed on each end face 2b. The anti-reflection coating film 2c is formed by, for example, ion-beam assisted deposition.

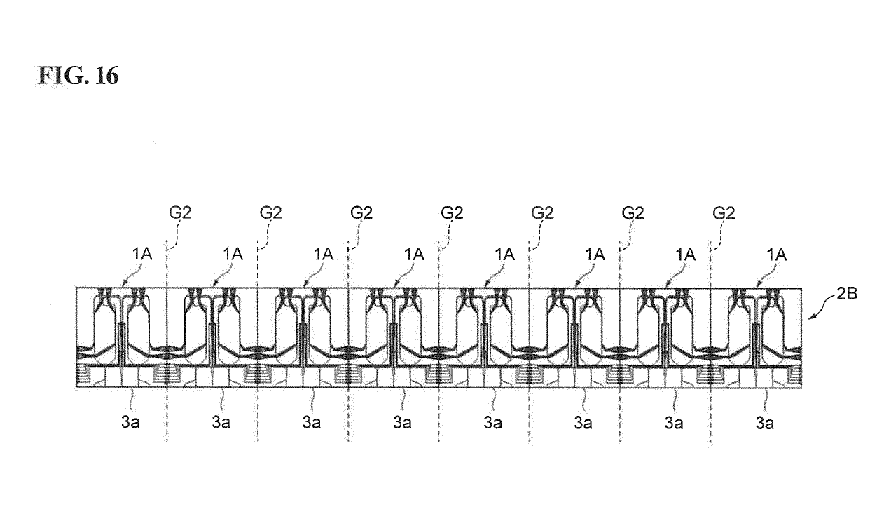

Next, as illustrated in FIG. 16, the product 2B is broken along cutting lines G2, which define the sides 3c and 3d illustrated in FIG. 1, to separate the semiconductor optical modulators 1A from each other in the form of chips. The semiconductor optical modulator 1A according to the present embodiment is manufactured by the above-described processes.

The advantages of the above-described semiconductor optical modulator 1A according to the present embodiment will now be described. When the semiconductor optical modulator 1A is used in a DP-QPSK optical communication system, continuous light is input to the input waveguide 4. The dividing portion 7 divides the continuous light along the eight arm waveguides 10a to 10h, that is, four pairs of arm waveguides. The light components propagated through four arm waveguides 10a to 10d are QPSK modulated by the modulation voltages applied by the modulation electrodes 31a to 31d. These light components are multiplexed by the first multiplexing portion 8, and the multiplexed light is output from one output waveguide 5. The light components propagated through the other four arm waveguides 10e to 10h are QPSK modulated by the modulation voltages applied by the modulation electrodes 31e to 31h. These light components are multiplexed by the second multiplexing portion 9, and the multiplexed light is output from the other output waveguide 6. The light output from the output waveguide 5 and the light output from the other output waveguide 6 are processed by an optical system outside the semiconductor optical modulator 1A so that the planes of polarization thereof are orthogonal to each other, and are then multiplexed into a DP-QPSK optical signal.

In the present embodiment, the input waveguide 4 and the two output waveguides 5 and 6 are provided on the same side 3a of the substrate 3. Therefore, optical components, such as lenses, of an optical communication device can be efficiently arranged. Furthermore, since the two output waveguides 5 and 6 are arranged symmetrically about the input waveguide 4, the optical components can be more efficiently arranged.

The input waveguide 4 may be disposed at the center of the side 3a as in the semiconductor optical modulator 1A according to the present embodiment. The semiconductor optical modulator 1A is manufactured by forming a plurality of the semiconductor optical modulators 1A arranged in horizontal and vertical directions on a single wafer 3A, and then cutting the wafer 3A to separate the individual semiconductor optical modulators 1A from each other, as illustrated in FIGS. 10 to 16. In the present embodiment, the two output waveguides 5 and 6 are arranged symmetrically about the input waveguide 4. Since the input waveguide 4 is at the center of the side 3a, the two output waveguides 5 and 6 and the input waveguide 4 are arranged symmetrically about the center of the side 3a of the substrate 3. Accordingly, as illustrated in FIG. 11, when the semiconductor optical modulators 1A are arranged adjacent to each other on the wafer 3A so that the sides 3a thereof oppose each other, the output waveguides 5 and 6 and the input waveguides 4 of the adjacent semiconductor optical modulators 1A are at the same positions. Therefore, the output waveguides 5 and 6 and the input waveguide 4 of one semiconductor optical modulator 1A can be formed continuously from the output waveguides 5 and 6 and the input waveguide 4 of another semiconductor optical modulator 1A, and the sides 3a can be formed by, for example, a cleaving process. As a result, additional regions that are generally provided between the adjacent semiconductor optical modulators 1A on the wafer 3A to enable separation therealong can be reduced, and the number of semiconductor optical modulators 1A that can be formed on a single wafer 3A (yield) can be increased. Since the input waveguides 4 face each other, the output waveguides 5 face each other, and the output waveguides 6 face each other, entrance and exit waveguides can be individually designed for each type of waveguides. Thus, the design flexibility can be increased. For example, the widths of the wide portions 4a and 5a and the lengths of the tapered portions 4b and 5b can be set individually.

The four arm waveguides 10a to 10d may be bent in the first winding path portion 12 toward a side opposite to a side toward which the other four arm waveguides 10e to 10h are bent in the second winding path portion 13 as in the semiconductor optical modulator 1A according to the present embodiment. With this structure, for example, the two output waveguides 5 and 6 may be arranged symmetrically about the input waveguide 4. In this case, the four arm waveguides 10a to 10d may have the same optical path length in the first winding path portion 12, and the other four arm waveguides 10e to 10h may have the same optical path length in the second winding path portion 13. Accordingly, the phase shift (skew) of the light components that reach the modulation electrodes 31a to 31h can be reduced, and the quality of the transmitted light can be increased.

The first winding path portion 12 may include the first bent portion 12a, the second bent portion 12b, the third bent portion 12c, the fourth bent portion 12d, and the fifth bent portion 12e as in the semiconductor optical modulator 1A according to the present embodiment. In such a case, the four arm waveguides 10a to 10d may be arranged to have the same optical path length in the first winding path portion 12.

The monitor waveguides 21 and 22 may be arranged symmetrically about the input waveguide 4 on the side 3a as in the semiconductor optical modulator 1A according to the present embodiment. Accordingly, optical components coupled to the monitor waveguides 21 and 22 can be efficiently arranged. When the input waveguide 4 is at the center of the side 3a, the monitor waveguides 21 and 22 of one semiconductor optical modulator 1A can be formed continuously from the monitor waveguides 21 and 22 of another semiconductor optical modulator 1A, and the sides 3a can be formed by, for example, a cleaving process. As a result, additional regions that are generally provided between the adjacent semiconductor optical modulators 1A on the wafer 3A to enable separation therealong can be reduced, and the number of semiconductor optical modulators 1A that can be formed on a single wafer 3A (yield) can be increased. Since the monitor waveguides 21 face each other and the monitor waveguides 22 face each other, entrance and exit waveguides can be individually designed for each type of waveguides. Thus, the design flexibility can be increased.

The semiconductor optical modulator according to the present invention is not limited to the above-described embodiment, and various modifications are possible. For example, in the above-described embodiment, the outer phase control electrodes 32a to 32d and the inner phase control electrodes are disposed between the input waveguide 4 and the winding path portions 12 and 13. However, according to the present invention, the outer phase control electrodes and the inner phase control electrodes may instead be disposed between the winding path portion 12 and the output waveguide 5 and between the winding path portion 13 and the output waveguide 6, for example, between the output waveguide 5 and the modulation electrodes 31a to 31d and between the output waveguide 6 and the modulation electrodes 31e to 31h. In such a case, the length of the modulator in direction A is longer than that in the above-described embodiment. However, effects similar to those of the embodiment can be provided.

What is claimed is:

1. A semiconductor optical modulator comprising:
an input waveguide provided on a side of a substrate;
a first and a second output waveguides provided on the side and arranged symmetrically about the input waveguide;
a dividing portion optically connected to the input waveguide;
eight arm waveguides, each arm waveguide being optically connected to the dividing portion;
a first multiplexing portion optically connecting four of the arm waveguides to the first output waveguide;
a second multiplexing portion optically connecting the other four of the arm waveguides to the second output waveguide; and
modulation electrodes provided on respective ones of the eight arm waveguides.

2. The semiconductor optical modulator according to claim 1, wherein the first output waveguide, the input waveguide, and the second output waveguide is arranged in that order at equal intervals along the side of the substrate.

3. The semiconductor optical modulator according to claim 1, further comprising:
a first monitor waveguide for monitoring light output from the first multiplexing portion; and
a second monitor waveguide for monitoring light output from the second multiplexing portion,
wherein the first monitor waveguide and the second monitor waveguide are arranged symmetrically about the input waveguide on the side.

4. The semiconductor optical modulator according to claim 1, wherein the four of the arm waveguides include a first winding path portion that is disposed between the dividing portion and the modulation electrodes,
wherein the other four of the arm waveguides include a second winding path portion that is disposed between the dividing portion and the modulation electrodes, and
wherein the four of the arm waveguides are bent in the first winding path portion toward a side opposite to a side toward which the other four of the arm waveguides are bent in the second winding path portion.

5. The semiconductor optical modulator according to claim 4, wherein the first winding path portion includes
a first bent portion in which the four of the arm waveguides are bent in a direction along the side,
a second bent portion in which, among the four of the arm waveguides extending from the first bent portion, two outer arm waveguides are bent in a direction toward the side,
a third bent portion in which, among the four of the arm waveguides extending from the first bent portion, two inner arm waveguides are bent at an angle greater than an angle of the direction toward the side,
a fourth bent portion in which the two inner arm waveguides extending from the third bent portion are bent in the direction toward the side, and
a fifth bent portion in which, among the two outer arm waveguides extending from the first bent portion, an inner arm waveguide is curved further inward.

6. The semiconductor optical modulator according to claim 5, wherein the four of the arm waveguides are bent 90° in the first bent portion,
wherein the two outer arm waveguides are additionally bent 90° in the second bent portion,
wherein the two inner arm waveguides are additionally bent 180° in the third bent portion, and
wherein the two inner arm waveguides are additionally bent −90° in the fourth bent portion.

7. The semiconductor optical modulator according to claim 1, wherein the dividing portion including four optical couplers,
wherein the first multiplexing portion including two optical couplers,
wherein the second multiplexing portion including two optical couplers, and
wherein the optical coupler of the dividing portion, the optical coupler of the first or the second multiplexing portion, the arm waveguides, and the modulation electrodes are included in four Mach-Zehnder modulators.
